(19) United States
(12) Patent Application Publication
(10) Pub. No.: US 2026/0250082 A1
(43) Pub. Date: Aug. 27, 2026

(54) TRANSFER DEVICE AND METHOD FOR HANDLING PACKING UNITS

(71) Applicant: TGW Logistics GmbH, Marchtrenk (AT)

(72) Inventor: Florian FORSTER, Bad Endorf (DE)

(73) Assignee: TGW Logistics GmbH, Marchtrenk (AT)

(21) Appl. No.: 18/872,461

(22) PCT Filed: Jun. 7, 2023
(86) PCT No.: PCT/AT2023/060180

§ 371 Date: Dec. 6, 2024

(30) Foreign Application Priority Data
Jun. 8, 2022 (AT) A 50400/2022

(51) Int. Cl. B65G 61/00; B25J 9/16

(52) U.S. Cl. CPC B65G 61/00; B25J 9/163; B25J 9/1653; B65G 2203/0208; B65G 2203/041

(57) ABSTRACT

The disclosure relates to a transfer device for handling packing units, comprising a gripping head with a base frame, on which a gripping module and a loading tongue module are mounted movably. The gripping module is movable relative to the loading tongue module in a lifting direction in order to lift the packing unit, such that the loading tongue module can extend beneath and support it.

### FIELD OF THE DISCLOSURE

The disclosure relates to a transfer device for handling packing units, comprising a gripping head, which has a base frame, a gripping module for lifting a packing unit, and a loading tongue module for supporting the packing unit, wherein the base frame defines a front plane and a rear plane and forms two side walls which extend between the front plane and the rear plane, the gripping module is mounted on the base frame, in particular by a drive device, so as to be movable in a lifting direction relative to the loading tongue and relative to the base frame, and the loading tongue is mounted on the base frame so as to be movable in an extending direction between a retracted initial position and an extended receiving position relative to the base frame and relative to the gripping module.

Furthermore, the disclosure relates to a method for handling a packing unit by a transfer device, wherein the transfer device comprises a gripping head, which has a base frame, a gripping module for lifting a packing unit, and a loading tongue module for supporting the packing unit, comprising the steps:
i) positioning of the gripping head in front of the packing unit;
ii) gripping of the packing unit by the gripping module;
iii) lifting of the packing unit by moving the gripping module relative to the base frame in a lifting direction, such that a gap is formed between the packing unit and a support upon which the packing unit rests;
iv) supporting of the packing unit by the loading tongue module by extending the loading tongue module in an extending direction from a retracted initial position into an extended receiving position and inserting the loading tongue into the gap, such that the loading tongue module extends beneath the packing unit;
v) lowering of the packing unit onto the loading tongue module by moving the gripping module relative to the base frame counter to the lifting direction in the direction of loading tongue module;
vi) positioning of the packing unit on the loading tongue module.

### BACKGROUND

The transfer device and the method can, in particular, be configured to unload and/or load a load carrier, for example a pallet, with packing units.

Transfer devices are known in the art which have a gripping head with a gripping module, wherein the gripping module has, as a rule, one or more gripping units.

A transfer device is known from EP 2 794 439 A1 that is configured to unload packing unit layers. The gripping module of that transfer device comprises a first gripping unit with a plurality of suction grippers for lifting what are referred to as intermediate layers. Furthermore, the gripping module comprises a second gripping unit, which is configured to lift packing units in layers by clamping grippers.

A further transfer device is known from EP 2 441 709 A1 that is configured to jointly handle adjacently arranged plastic crates or banana crates. The gripping module of that transfer device comprises a first and a second gripping unit. On the one hand, the first gripping unit is configured to lift plastic crates and comprises jointly acting positive and nonpositive gripping means, namely hooks and clamping means. The disadvantage thereof is that the plastic crates have to be accessible from at least three sides so that they can be clamped from the side and hooked at the front. On the other hand, the second gripping unit is configured to lift banana crates and also comprises jointly acting positive and nonpositive gripping means, namely pins and suction grabbers. Be-cause the gripping units are not movable relative to the loading tongue, it is thereby necessary for the packing units to be completely lifted so that the loading tongue can extend beneath them.

Furthermore, a transfer device is known from WO 2020 014725 A2 that is configured to unload a transport loading aid using clamping grippers. The gripping module thereby comprises two interacting clamping means that can be positioned against a packing unit in order to fix it by clamping. The disadvantage thereof is that the opposite side walls of the packing unit have to be accessible in order for the packing unit to be fixed by clamping.

### OVERVIEW

An object of the disclosure is thus to provide an improved transfer device and a corresponding method for handling packing units. In particular, secure lifting of individual packing units ought to be enabled.

The problem is solved by a transfer device of the type mentioned at the beginning by the gripping module having a plurality of gripping units of different gripping types, which are configured to contact a contact side of the packing unit and are alternately activatable, and the transfer device having a control system which is configured to acquire a grippability of the packing unit, to determine a gripping type based on the grippability that is suitable for lifting the packing unit, to (automatically) select a gripping unit corresponding to the determined gripping type, and to initiate an activation of the selected gripping unit.

An advantage achieved by the disclosure is in particular that the transfer device can be adapted to a packing unit to be lifted by selecting different gripping means that are suitable for the respective packing unit.

The grippability specifies with which gripping unit or gripping type the packing unit can be gripped or lifted. The grippability can thereby be based on a surface property, a side accessibility, a weight, a weight distribution of the packing unit, and/or similar.

The acquisition of the grippability can be performed by the packing unit being identified and master data, comprising the grippability, stored in an electronic memory being accessed by the control system. Alternatively, it can also be provided that the acquisition of the grippability is performed by evaluating the contact side, in particular a surface property of the contact side.

The contact side of the packing unit can be understood as being the side that the (selected) gripping unit, in particular the front plane, is facing. The contact side is preferably aligned vertically. It is particularly preferable for the contact side to be formed by a front wall of the packing unit.

Different gripping types can each comprise gripping means that act according to a different operating principle, for example according to a nonpositive or positive engagement principle.

It is advantageous if the gripping types are selected from a group comprising one or more nonpositive gripping types and/or one or more positive gripping types. It is expedient if the gripping unit comprises one or more gripping means of the respective gripping type.

The nonpositive gripping types can be selected from a group comprising vacuum gripping types, clamping gripping types, magnet gripping types. Corresponding gripping means can, for example, be configured as vacuum gripping means, as clamping means, as magnet gripping means, or similar.

In addition, the positive gripping types can be selected from a group comprising hook gripping types, pin gripping types, screw gripping types, bayonet gripping types, or similar. Corresponding gripping means can, for example, be configured as hooks, as (spring-mounted) pins, as screws, as part of a bayonet coupling, or similar.

It is expedient if the gripping units each comprise one or more gripping means.

In order to secure heavy packing units or packing units during dynamic or fast movements of the gripping head, it can be provided that a plurality of gripping means of different gripping types are activated and/or active at the same time.

It is particularly preferred for a (first) gripping unit of a first gripping type and optionally a further (first) gripping unit of the first gripping type, in particular of a nonpositive gripping type, to comprise one or more vacuum gripping means.

Furthermore, it can be advantageous if a (second) gripping unit of a second gripping type and optionally a further (second) gripping unit of the second gripping type, in particular of a positive gripping type, comprises one or more positive gripping means, preferably spring-mounted pins.

It is expedient if the control system is configured to access master data of the packing unit stored in an electronic memory and/or to store master data of the packing unit in the electronic memory. Thus, on the one hand, known master data do not have to be obtained again. On the other hand, newly gained information about the packing unit can be stored as master data.

The master data can comprise data relating to the grippability of the packing unit, a weight of the packing unit, a weight distribution or a center of gravity of the packing unit, a material of the packing unit, a material surrounding the packing unit, a dimension of the packing unit, and/or similar.

It is advantageous if the control system comprises a reader device for acquiring an identification marker of the packing unit, for example a barcode, QR code or RFID tag.

The control system can be configured to identify the packing unit by means of the identification marker and to access master data assigned to the identified packing unit from the electronic memory or to store such data in the electronic memory. It can thereby be provided that an identification marker is arranged on every packing unit. Alternatively, it can be provided that a packing unit container consisting of a plurality of packing units has an identification marker. This is particularly expedient if positions of the packing units within the packing unit container are known or if the packing unit container consists of a plurality of identical packing units.

Furthermore, it can be provided that the control system has an image capturing system for capturing an image of the contact side of the packing unit, for example a camera, and an evaluation unit, wherein the evaluation unit is configured to detect a surface property of the contact side based on an image captured by the image capturing system and to determine the grippability based on the surface property. New master data can thereby be acquired or generated, for example, or the gripping type detected, without the grippability of the packing unit having to be known beforehand. It is expedient in this regard if the image capturing system has a data connection with the evaluation unit. It is expedient if an optical axis of the image capturing system extends parallel to the extending direction or orthogonally to the front plane.

The evaluation unit can comprise an algorithm by means of which the surface property of the contact side is evaluated, in particular an image recognition algorithm.

It is advantageous if the control system has a monitoring unit which is configured to acquire the gripping parameters during lifting of the packing unit and to store training data in an electronic memory, wherein the training data comprise the determined grippability and acquired gripping parameters and wherein the evaluation unit for detecting the grippability comprises a machine learning module which can be trained using the training data.

The machine learning model can comprise the image recognition algorithm. Training of the machine learning model is preferably performed by unmonitored, (partially) monitored, and/or reinforcement learning. The training data can, in particular, comprise the aforementioned master data.

It is preferably provided that the gripping head has a clamping unit for fixing the packing unit that comprises two interacting clamping means that are mounted on the base frame so as to be movable relative to one another in order to generate a clamping force, in particular on the packing unit. The packing unit can thereby be fixed and/or aligned on the gripping head in a simple manner. It is particularly preferable for the clamping unit to comprise one of the gripping units.

In order to position clamping means against the side walls of the packing unit and thereby generate a clamping force acting on the packing unit, the clamping means can be movable towards one another. For this purpose, the clamping means can be moved relative to one another from an opened position into a clamping position. In the clamping position, a spacing between the clamping means is smaller than in the opened position. In the clamping position, the spacing substantially corresponds to the width of the packing unit, such that the packing unit is fixed on opposite side walls by clamps.

It can thereby be advantageous if one of the clamping means, in particular a first clamping means, can be provided in an abutment position. Moreover, it can be provided that another of the clamping means, in particular a second clamping means, can be provided in the opened position. According to a first embodiment of the clamping unit, the second clamping means can be movable in the direction of the first clamping means from the opened position into the clamping position. According to a second embodiment of the clamping unit, the first and second clamping means are movable towards one another, such that they are movable from the (moved apart from one another) opened position into the (moved towards one another) clamping position.

It is expedient if at least one of the clamping means is movable between a stowed position and an operating position, wherein the front plane and the outer surfaces of the side walls facing away from one another delimit an interior space and the at least one clamping means is arranged completely in the interior space in the stowed position and at least partially outside the interior space in the operating position. A further advantage achieved thereby is, in particular, that no interfering contour protrudes on the side walls or on at least one side wall, such that the gripping module can, for example, be positioned as close as possible to a wall. That also allows for packing units that are arranged on a wall or next to another packing unit to be reliable lifted or dispensed as close as possible to a wall and thus very reliably.

The abutment position can correspond to the operating position of the first clamping means. The opened position can correspond to the operating position of the second clamping means.

Furthermore, it can be provided that the clamping unit comprises a drive device for moving the clamping means. It can thereby be provided that the drive device comprises a separate drive for each clamping means, such that they can be moved individually.

It is expedient if the loading tongue module comprises two loading tongues arranged next to one another, which have a lateral connecting contour with alternating protrusions and recesses along a side facing the respective other loading tongue, and the gripping head can be brought into a first configuration in which the loading tongues are arranged at a minimum spacing to one another and the connecting contours of the loading tongues engage with one another, and a second configuration in which the loading tongues are arranged at a maximum spacing to one another, wherein the maximum spacing is greater than the minimum spacing. An advantage achieved thereby is, in particular, that due to the lateral connecting contour a rest surface is increased when the loading tongues are moved apart and the rest surface can be adjusted to a width of the packing unit and thus maximized by adjusting a width or the spacing between the loading tongues. Reliable handling of packing units, in particular dimensionally unstable or heavy packing units, is thus guaranteed.

To adjust a spacing between the loading tongues, it is advantageous if the loading tongues are movable relative to one another in a width direction.

The minimum spacing between the loading tongues is preferably substantially zero, such that they adjoin one another. It is particularly preferable for a spacing between the loading tongues to be steplessly adjustable from a minimum spacing to a maximum spacing. The loading tongue module can thereby be brought into different configurations and is thus individually adjustable to a width of the packing unit.

In the extended receiving position, the loading tongue module preferably protrudes beyond the front plane such that the packing unit can be placed on the loading tongue module.

It is advantageous if the loading tongue module closes in a flush manner with the front plane in the retracted initial position or is arranged in a set back manner from the front plane towards the rear plane. Thus, the loading tongue module does not form an interfering contour during positioning of the gripping head.

It is particularly preferably provided that the loading tongue(s) each has/have a plate-like configuration.

Furthermore, it can be provided that the loading tongue module comprises a drive device for moving the loading tongue module, in particular the loading tongue(s). When there are several loading tongues, it can be provided that the drive device comprises a separate drive for each loading tongue, such that they can be moved individually.

It is preferably provided that the gripping module is movable parallel to the extending direction between a retracted inactive position and an active position upstream of the inactive position in the extending direction. It is particularly preferably provided that gripping units of the gripping module, in particular the gripping units of different gripping types, are movable independently of one another parallel to the extending direction between the inactive position and the active position. The gripping units can selectively be movable into the active position in order to activate the respective gripping unit.

It is particularly preferable for the gripping module to comprise a first and second gripping unit, in particular of different gripping types, that are movable individually of one another, such that the first or the second gripping unit is selectively movable into the active position. It can thereby be advantageous if in a first gripping configuration the first gripping unit is in the use position and the second gripping unit in the initial position and/or in a second gripping configuration the first gripping unit is in the initial position and the second gripping unit in the use position.

It is expedient if the gripping head comprises a clamping element that protrudes beyond the front plane, in particular beyond the gripping module or gripping unit(s), which is movable parallel to the lifting direction relative to the loading tongue and is mounted movably on the base frame in order to generate a clamping force between the clamping element and the loading tongue. The packing unit can thereby be fixed. In addition, the packing unit can be prevented from tipping forward off the loading tongue.

To detect or localize, for example, a stack height of a packing unit stack and/or an upper edge of a packing unit to be received, the gripping head can comprise a contacting element that protrudes beyond the front plane, in particular beyond the gripping module or gripping unit(s), and a contacting sensor mechanism, wherein the contacting element is movable between a contacting position and an actuating position and the contacting sensor mechanism is configured to detect a movement of the contacting element from the contacting position into the actuating position. The contacting element is preferably formed by the clamping element. The contacting element can alternatively be configured as a sensing finger.

To acquire or monitor a horizontal positioning of the gripping head relative to the packing unit, it can be provided that the gripping head comprises a camera unit that is mounted on the base frame such that it protrudes beyond the front plane in the extending direction, wherein an optical axis of the camera unit extends parallel to the lifting direction.

Furthermore, it is advantageous if the gripping module comprises at least two gripping units of the same gripping type, which are movable relative to one another in the width direction in order to adjust a spacing between them. A receiving width for receiving packing units of different widths can thereby be adjusted.

Furthermore, it is expedient if the side walls of the base frame are movable relative to one another in the width direction in order to adjust a spacing between them.

It is advantageous if the base frame forms a support structure for the gripping module and the loading tongue, as well as for the clamping unit where applicable. The front plane, defined by the base frame, and the rear plane preferably extend parallel to one another. Similarly, the side walls also preferably extend parallel to one another.

To position the gripping head relative to the packing unit and/or to transfer the packing unit from a source location to a target location, it is preferably provided that the gripping head is (automatically) spatially movable.

It is expedient if the transfer device comprises a manipulation unit by means of which the gripping head is (automatically) spatially movable. The manipulation unit is preferably configured as a gantry robot or an articulated-arm robot.

The lifting direction is preferably aligned parallel to the front plane and parallel to the side walls. Furthermore, the extending direction is preferably aligned orthogonally to the front plane and parallel to the side walls. Moreover, the width direction is preferably aligned parallel to the front plane and orthogonally to the side walls. It is particularly preferable for the lifting direction, the extending direction and the width direction to each, in pairs, form an angle of 90°.

It is advantageous if the gripping head can be brought into a neutral position in which the lifting direction extends vertically. The extending direction and the width direction thereby extend horizontally.

By utilizing the aforementioned advantages and effects, the object of the disclosure is further solved by an order-picking system that has a transfer device or a plurality of transfer devices for handling packing units, wherein the transfer devices are configured according to one of the aforementioned aspects.

The order-picking system can, in particular, comprise a source location and a target location, wherein the transfer device is configured to transfer packing units from the source location to the target location.

Furthermore, the order-picking system can have a provisioning device for providing packing units, in particular on source load carriers, at the source location. The provisioning device can comprise a conveying system for transporting the packing units to the source location, in particular on source load carriers. Likewise, the order-picking system can comprise a conveying system for transporting the packing units, in particular on target load carriers, from the target location and/or a provisioning device for providing target load carriers at the source location.

It is particularly preferable for the transfer device to be configured to remove packing units from source load carriers and/or place packing units on target load carriers or the conveying system.

The transfer device of the order-picking system is configured in particular to process a picking order and can thus be part of an order-picking system or constitute one. Packing units according to the picking order can thereby be transferred from a source load carrier provided at the source location to a target load carrier provided at the target location.

Using the aforementioned advantages and effects, the object according to the method in a method of the type mentioned at the beginning is solved by the gripping module having a plurality of gripping units of different gripping types and step ii) comprising the following steps:
acquisition of a grippability of the packing unit by a control system, wherein the grippability indicates a gripping type that is suitable for lifting the packing unit;
selection of a gripping unit from the gripping units of different gripping types depending on the grippability acquired by the control system;
activation of the selected gripping unit by the control system;
generation of a releasable connection between the selected gripping unit and a contact side of the packing unit.

The acquisition of the grippability can comprise accessing the grippability from an electronic memory and/or an evaluation of the surface property of the contact side. A gripping unit suited for lifting is selected and subsequently activated based on the acquired grippability.

It is expedient if packing units with a smooth surface are assigned to a first grippability which indicates that the nonpositive gripping type, in particular a gripping unit comprising vacuum gripping means, is suitable for lifting the packing unit. Furthermore, it is advantageous if packing units with a structured surface are assigned to a second grippability which indicates that the positive gripping type, in particular a gripping type comprising spring-mounted pins, is suitable for lifting the packing units.

It is advantageous if upon activation a relative movement is performed between the selected gripping unit and the at least one other gripping unit of the plurality of gripping units, wherein the selected gripping unit is positioned upstream in the extending direction of the at least one other gripping unit. The relative movement can be performed by the selected gripping means being moved in the extending direction and/or the at least one not selected gripping means being moved counter to the extending direction.

It is advantageously provided that the acquisition of the grippability comprises a step of identifying the packing unit. This can, for example, be performed as described above by acquiring and evaluating an identification marker that is arranged on the packing unit. Alternatively, the packing unit can be identified from a gripping order, wherein the gripping order comprises the position of the packing unit and where applicable the respective master data.

Furthermore, it is expedient if the acquisition of the grippability comprises a step of transferring the grippability of the identified packing unit from an electronic memory to the control system. This can, for example, comprise a receipt of data relating to the grippability from the control system, which can be transmitted from a superordinate master computer to the control system, for instance. Alternatively or in addition, this transmission can comprise the control system accessing data of that kind from the electronic memory.

Moreover, it is advantageous if the acquisition of the grippability comprises a step of capturing an image of the contact side by means of an image capturing system and a step of evaluating the (captured) image by means of an evaluation unit in order to detect a surface property. The evaluation of the image can, for example, be performed as described above by means of an image recognition algorithm. Furthermore, it is expedient if the acquisition of the grippability subsequently comprises a step of determining a grippability of the packing unit based on the surface property.

In general, the surface property can indicate whether, for example, materials or structures are present which impair a suction effect of the gripping means or enable a positive connection of the gripping means if the gripping means is configured accordingly. For instance, the surface property can indicate a surface roughness and/or a surface structure and/or similar. In particular, the surface property can indicate whether protrusions, recesses, a plastic film, dirt, water droplets or the like are present on the contact side.

It is particularly preferably provided that when acquiring the grippability, the grippability is selectively transmitted from an electronic memory to the control system or a captured image of the contact side is evaluated and the grippability of the packing unit is determined based on the surface property, depending on whether the grippability is stored in the electronic memory.

It is expedient if the evaluation of the image is performed by means of a machine learning model.

Furthermore, it is expedient if the method comprises a step vii) of acquiring gripping parameters. The gripping parameters thereby relate to or indicate a quality of the connection between the selected gripping unit and the contact side. The acquisition of the gripping parameters is preferably performed during steps ii), iii), iv) and/or v). The gripping parameters can thereby be assigned to the gripping type and the detected surface property in order to provide training data. It is expedient if the method comprises a step viii) of training the machine learning model using the training data. The training of the model can be performed as described above.

It is advantageous if the positioning of the packing unit according to step vi) comprises a step of providing, at opposite sides of the packing unit, two interacting clamping means of a clamping unit mounted on the base frame.

Furthermore, the fixing of the packing unit can comprise a step of aligning and/or clamping the packing unit between the clamping means by reducing a spacing between the clamping means. The packing unit can thereby be brought into a well-defined position and/or be reliably fixed by clamps during a movement of the gripping head

Upon alignment, the packing unit can, for example, be positioned centrally on the loading tongue module by both clamping means being moved towards one another. Alternatively, the packing unit can be positioned against a fixed stop provided by a first clamping means of the clamping means by sliding the packing unit in the direction of the first clamping means on the loading tongue module by moving a second clamping means of the clamping means. To clamp, the two clamping means are moved so far towards one another or the second clamping means so far in the direction of the first clamping means until the packing unit is fixed between the interacting clamping means.

For alignment and/or clamping, the clamping means are first provided in the opened position as described above and subsequently moved relative to one another into the clamping position, wherein the spacing between the clamping means is reduced.

It is further expedient if the positioning according to step vi) comprises a step of releasing the connection between the gripping unit and the contact side after the lowering of the packing unit according to step v), wherein the alignment and/or clamping of the packing unit is performed after the release of the connection.

Using the aforementioned advantages and effects, the object according to a method of the type mentioned at the beginning is thus further solved by the positioning according to step vi) comprising the following steps:
provision at opposite sides of the packing unit of two interacting clamping means of a clamping unit mounted on the base frame;
releasing the connection between the gripping unit and the contact side after the lowering of the packing unit according to step v);
alignment and/or clamping of the packing unit between the clamping means by reducing a spacing between the clamping means.

It is expedient if the alignment and/or clamping of the packing unit comprises the following steps:
provision of a first clamping means of the clamping means in an abutment position, in particular as previously described;
movement of a second clamping means of the clamping means in the direction of the first clamping means;
sliding the packing unit in the direction of the first clamping means by the second clamping means until the packing unit contacts the first clamping means.

When moving the second clamping means, the latter is preferably provided in the previously described operating position of the second clamping means or in the opened position and subsequently moved into the clamping position.

The sliding of the packing unit is preferably performed by the movement or during the movement of the second clamping means.

To prevent the packing unit from tipping forwards, it is advantageously provided that the positioning in step vi) comprises the following steps:
provision of a clamping element which protrudes beyond the gripping module and is mounted on the base frame so as to be movable relative to the loading tongue module,
positioning of the clamping element in a basic position, in which the clamping element is positioned above the packing unit and protrudes in the extending direction beyond the packing unit,
moving the clamping element from the basic position into a fixing position, wherein the clamping element is positioned against an upper edge of the packing unit and the packing unit is fixed by clamping between the clamping element and a loading tongue of the loading tongue module.

Furthermore, it can be provided that the positioning of the gripping head according to step i) comprises the following steps:
provision of a contacting element that is mounted on the base frame so as to be movable relative to the loading tongue module, in a contacting position in which the contacting element protrudes beyond the gripping module;
horizontal positioning of the gripping head, wherein the gripping head is moved into a first position in which the contacting element protrudes beyond the packing unit and the gripping module is arranged parallel to the extending direction at a distance to the contact side;
vertical positioning of the gripping head, wherein the contacting element is provided in a contacting position in which the contacting element is positioned at a lower end of the gripping module and the gripping head is lowered until the contacting element is moved from a contacting position into an actuating position by touching an upper edge of the packing unit, whereupon the gripping head is further lowered, such that the loading tongue module is aligned on a lower edge of the packing unit.

During vertical positioning, a movement of the contacting element from the contacting position into the actuating position can be detected by the contacting sensor mechanism. A position of the upper edge and thus the stack height can be determined by the touching of the upper edge and the movement of the contacting element thereby initiated. A receiving level at which, for example, the loading tongue is to be positioned and/or extended in order to receive the packing unit to be received can be detected based on the stack height.

The packing unit can comprise a single packing item or a plurality of packing items, in particular stacked on top of one another. For example, a packing item can be a container, a box, a crate, a case or similar.

A packing unit to be handled can be provided at the transfer device individually or as part of a packing unit container. The packing unit container can comprise a plurality of packing units, in particular stacked on top of one another.

Preferably, packing units and/or the packing unit containers are provided on load carriers, in particular source load carriers, from which the packing unit is to be lifted. Equally, it can be provided that the packing units are to be dispensed onto load carriers, in particular target load carriers.

Such a load carrier, in particular a source or target load carrier, can, for example, be configured as a tray, pallet, roll cage, transport rack or similar.

### BRIEF DESCRIPTION OF THE FIGURES

For a better understanding of the disclosure, it is explained in more detail with reference to the following figures.

These show in highly simplified, schematic representation:

FIG. 1a to 2b a gripping head of a transfer device;

FIG. 3a the transfer device with a packing unit with a smooth surface;

FIG. 3b the transfer device with a packing unit with a structured surface;

FIGS. 4a to 4d a receipt of the packing unit by the transfer device in side view;

FIG. 5a to 5c an alignment of the packing unit on the loading tongues;

FIG. 6a a first transfer of a packing unit by the transfer device in an order-picking system;

FIG. 6b a second transfer of a packing unit by the transfer device in an order-picking system;

FIG. 7 a method for handling a packing unit;

FIG. 8 positioning of a gripping head of the transfer device;

FIG. 9 gripping of the packing unit;

FIG. 10 acquisition of the packing unit;

FIG. 11 further acquisition of the packing unit;

FIG. 12 alignment or fixing of the packing unit;

FIG. 13 vertical clamping of the packing unit;

FIG. 14 horizontal clamping of the packing unit.

It is worth noting here that the same parts have been given the same reference numerals or same component configurations in the embodiments described differently, yet the disclosures contained throughout the entire description can be applied analogously to the same parts with the same reference numerals or the same component configurations. The indications of position selected in the description, such as above, below, on the side etc. refer to the figure directly described and shown, and can be applied in the same way to the new position should the position change.

### DETAILED DESCRIPTION OF THE EMBODIMENTS

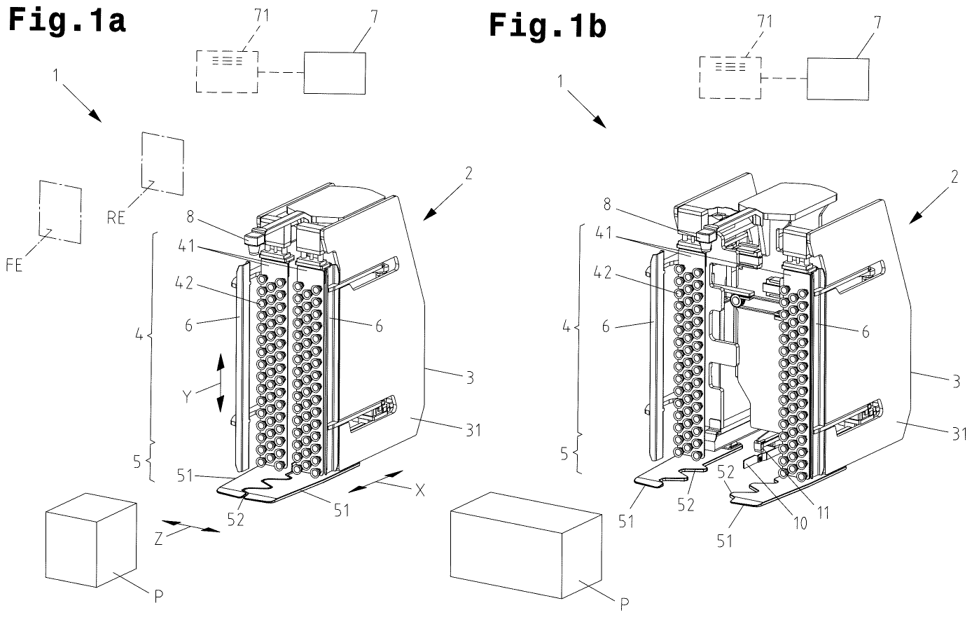

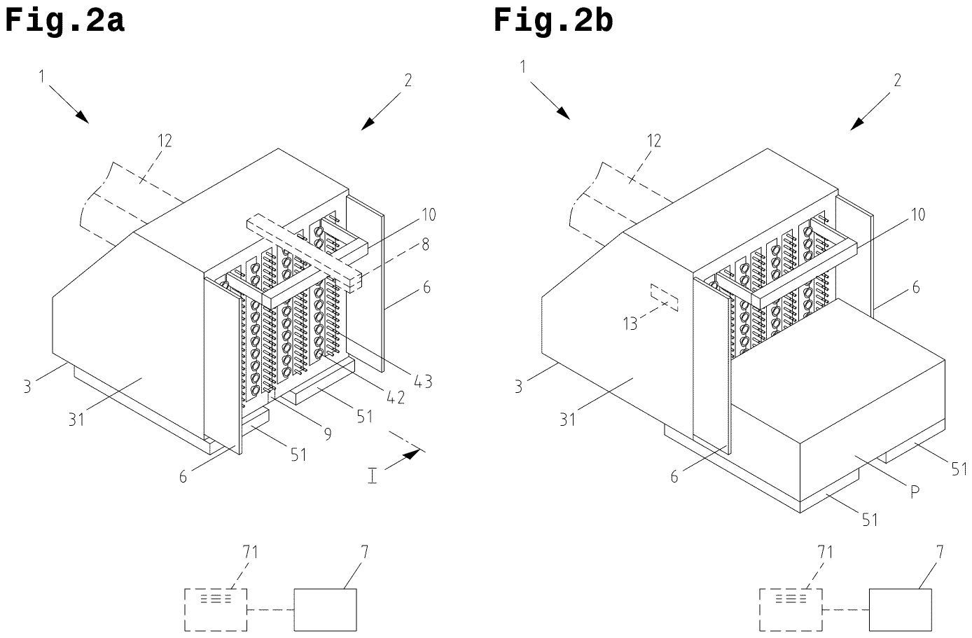

FIG. 1a to FIG. 2b show a perspective view of a transfer device 1 for handling packing units P. The transfer device 1 comprises a gripping head 2 comprising a base frame 3, a gripping module 4 and a loading tongue module 5. FIG. 2a and FIG. 2b show the transfer device 1 in a highly simplified representation.

The base frame 3 defines a front plane FE and a rear plane RE, as shown by way of example in FIG. 1a by means of a dash-dotted line. In addition, the base frame 3 forms two side walls 31 that extend between the front and rear plane RE.

Optionally, the gripping head 2 can be configured with a first width as shown in FIG. 1a in a first configuration and/or with a second width as shown in FIG. 1b in a second configuration. It is particularly preferable for the gripping head 2 to be (steplessly) adjustable between these configurations.

For this purpose, it can be provided that the side walls 31 are movable in relation to one another in a width direction Z in order to adjust a spacing between the side walls 31. As can be seen from FIG. 1a and FIG. 1b, the spacing in the first configuration can be smaller than in the second configuration. This adjustability makes it possible to reliably receive packing units P of different sizes. The first configuration can correspond to a minimum configurable spacing between the side walls 31. The second configuration can correspond to any other spacing between the side walls 31, in particular one which is greater than the minimum configurable spacing. The other spacing is expediently smaller than or equal to a maximum configurable spacing between the side walls 31.

The gripping module 4 and the loading tongue module 5 are mounted movably on the base frame 3. The base frame 3 thus substantially forms a support structure for them.

Moreover, the gripping module 4 is mounted on the base frame 3 so as to be movable in a lifting direction and comprises at least one gripping unit 41. Preferably, the gripping module 4 comprises a plurality of, in particular two, gripping units 41, as is shown by way of example in FIG. 1a and FIG. 1b. The gripping units 41 shown are configured according to the same gripping type.

As shown by way of example, the gripping units 41 can be configured according to a nonpositive gripping type, in particular according to a vacuum gripping type, and can comprise a plurality of vacuum grippers. Of course, gripping units 41 of another gripping type can be provided instead of the gripping units 41 shown.

Additionally or alternatively to the gripping units 41 of the nonpositive gripping type as shown in FIG. 1a and FIG. 1b, the gripping module 4 can also comprise gripping units 41 of the positive gripping type which each have a plurality of positive gripping means 43. The positive gripping means 43 can, for example, be configured as spring-mounted pins.

The gripping module 4 can thus comprise a plurality of, in particular two or four, gripping units 41 of the same gripping type and/or a plurality of, in particular two or four, gripping units 41 of different gripping types.

If the gripping head 2 is adjustable between the first and second configuration, it can also be provided that the gripping units 41 of the same gripping type are movable in the width direction in relation to one another in order to adjust a spacing between them, as can be seen by consulting FIG. 1 and FIG. 1b together.

Furthermore, it is advantageous if the gripping module 4, in particular the gripping units 41, is individually movable in the extending direction X between a retracted inactive position and an upstream active position.

In order to lift the packing unit P relative to the loading tongue module 5, the gripping unit 41 is mounted on the base frame 3 so as to be movable in a lifting direction Y. The lifting direction Y is shown by way of example in FIG. 1a as a double arrow.

The loading tongue module 5 is mounted on the base frame 3 so as to be movable in an extending direction X between a retracted initial position and an extended receiving position. The retracted initial position is shown in FIG. 2a. Furthermore, the extended initial position is shown in FIG. 1a, FIG. 1b and FIG. 2b. The extending direction X is shown by way of example in FIG. 1a as a double arrow.

The packing unit P can be received on the loading tongue module 5, as is shown in FIG. 2b.

Preferably, the loading tongue module 5 comprises a plurality of, in particular two, loading tongues 51. Alternatively, the loading tongue module 5 can comprise a single loading tongue 51, which is not explicitly shown. It is particularly preferable for the loading tongues 51 or the single loading tongue 51 to have a plate-like configuration.

It is expedient if the loading tongues 51, analogously to the side walls 31 and gripping units 41, are movable in the width direction Z in order to adjust a distance between them.

The gripping head 2 in FIG. 1a is shown in a first configuration in which the loading tongues 51 are arranged at a minimum spacing to one another. As can be seen from FIG. 1a, the minimum spacing between the loading tongues 51 can be substantially zero, such that they adjoin each other. In addition, the gripping head 2 in FIG. 1b is shown in a second configuration in which the loading tongues 51 are arranged at a wider spacing to one another that is greater than the minimum spacing.

To widen a rest surface for the packing unit P, in particular in the second configuration, it can be provided that the loading tongues 51 have lateral connecting contours 52 each comprising protrusions and recesses. In the first configuration, the protrusions and recesses of the adjacently arranged loading tongues 51 engage with one another, as can be seen from FIG. 1a. The second configuration can, for example, be selected such that the protrusions and recesses only partially or no longer engage with one another, as shown in FIG. 1b. In the example shown, the connecting contour 52 has a substantially wavelike or zig-zag configuration.

To align and/or fix the packing unit P on the loading tongue module 5, the gripping head 2 can have a clamping unit with two interacting clamping means 6, as can be seen in the example shown. The clamping means 6 are substantially arranged on both sides of the base frame and mounted thereon. As shown in FIG. 1a to FIG. 2b, it is preferably provided that the clamping means 6 are arranged on the side or in the width direction Z flush with the respective side wall 31.

It is further provided that the clamping means 6, as shown in FIG. 1a by a double arrow, are movable relative to one another in the width direction Z, in particular are movable towards one another, in order to generate a clamping force or slide the packing unit P on the loading tongue 5.

Furthermore, the clamping means 6 can be movable in the extending direction X between a (retracted) stowed position and an (extended) operating position. On the one hand, the respective clamping means 6 in the stowed position ends in line with the front plane FE, i.e. does not protrude beyond the latter. On the other hand, the respective clamping means 6 in the operating position does protrude beyond the front plane FE. In FIG. 1a and FIG. 1b, one of the clamping means 6 (left) is arranged in the operating position and the other clamping means 6 (right) is arranged in the stowed position. The clamping means 6 shown in FIG. 2a and FIG. 2b are each shown positioned in the operating position.

It is expedient if the transfer device 1 comprises a control system 7, as represented schematically. The control system 7 is configured to control the transfer device 1, in particular the gripping module 4, the loading tongue module 5 and/or the clamping unit, to acquire a grippability of the packing unit P, to select a gripping unit 41 and/or to initiate an activation of the selected gripping unit 41. Preferably, the control system 7 has a data connection with or comprises an optional electronic memory 71. The optional electronic memory 71 is represented by a dashed line.

In addition, the gripping head 2 can comprise an optional camera unit 8 that protrudes in the extending direction X beyond the gripping module 4 and the optical axis of which extends parallel to the lifting direction Y, as is shown by way of example in FIG. 1a to FIG. 2 b. A horizontal positioning process can be monitored using this camera unit 8.

To capture an image of a contact side of the packing unit P, the control system 7 can have an image capturing system 9. The image capturing system 9 is preferably arranged on the gripping head 2. It is expedient if the control system 7 comprises an evaluation unit for evaluating the captured image with which the image recognition system 9 has a data connection. An optical axis of the image capturing system 9 preferably extends parallel to the extending direction X. The image capturing system 9 usually comprises a camera.

For vertical positioning, the gripping head 2 can have a contacting element 10 that protrudes beyond the front plane FE. The contacting element 10 is thereby movable in the lifting direction Y.

To fix the packing unit P on the loading tongue 51, it can also be provided that the contacting element 10 is used as a clamping element. Such a contacting element 10 or clamping element can optionally be provided in all embodiments described and is not shown in FIG. 1a and FIG. 1b for the sake of clarity.

To automatically move and/or align the transfer device 1 or the gripping head 2, it can comprise a manipulation unit 12 on which the gripping head 2 is mounted. Such a manipulation unit 12 can be provided in all embodiments described and for the sake of clarity is only shown in FIG. 2a and FIG. 2b, represented by a dashed line.

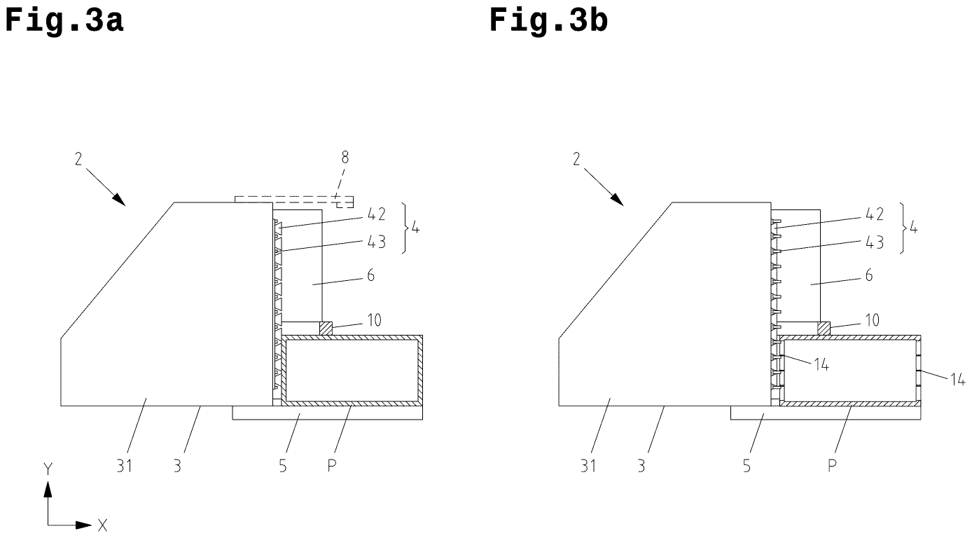

FIG. 3 a shows the transfer device 1 in a simplified representation in a cross section along line I from FIG. 2a. It can thereby be seen that the previously described camera unit 8 and the contacting element 10 protrude beyond the front plane FE, in particular beyond the gripping module 4, in the extending direction X.

In FIG. 3 a a packing unit P has been received by the transfer device 1, wherein the gripping unit 41 of the nonpositive gripping type is activated and a releasable connection between vacuum gripping means 42 of this gripping unit 41 and a contact side of the packing unit P is established. For this purpose, the gripping unit 41 of the nonpositive gripping type is activated by the vacuum gripping means 42 being positioned upstream of the positive gripping means 43. In this example, the packing unit P comprises a contact side with a smooth surface, such that the vacuum gripping means 42 adjoin in a sealed manner with said surface, thus establishing a releasable connection by applying a vacuum.

Furthermore, in FIG. 3b a packing unit P has been received by the transfer device 1, wherein the gripping unit 41 of the positive gripping type is activated and a releasable connection between positive gripping means 43 of this gripping unit 41 and a contact side of the packing unit P is established. For this purpose, the gripping unit 41 of the positive gripping type is activated by positioning the positive gripping means 43 upstream of the vacuum gripping means 42. In this example, the packing unit P comprises a contact side with a structure surface on which several bars 14 are arranged. The positive gripping means 43 engage with these bars 14 to establish the releasable connection.

As shown in FIG. 3a and FIG. 3b, the contacting element 10 can be positioned against the upper edge or an upper side of the packing unit P respectively. The upper edge can thereby be detected and/or the packing unit P fixed on the loading tongue module 5.

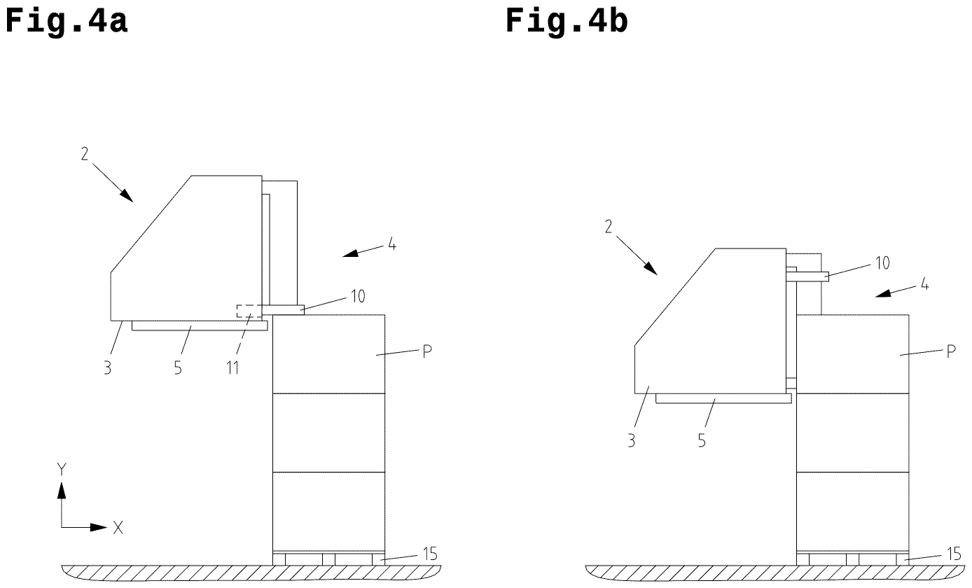

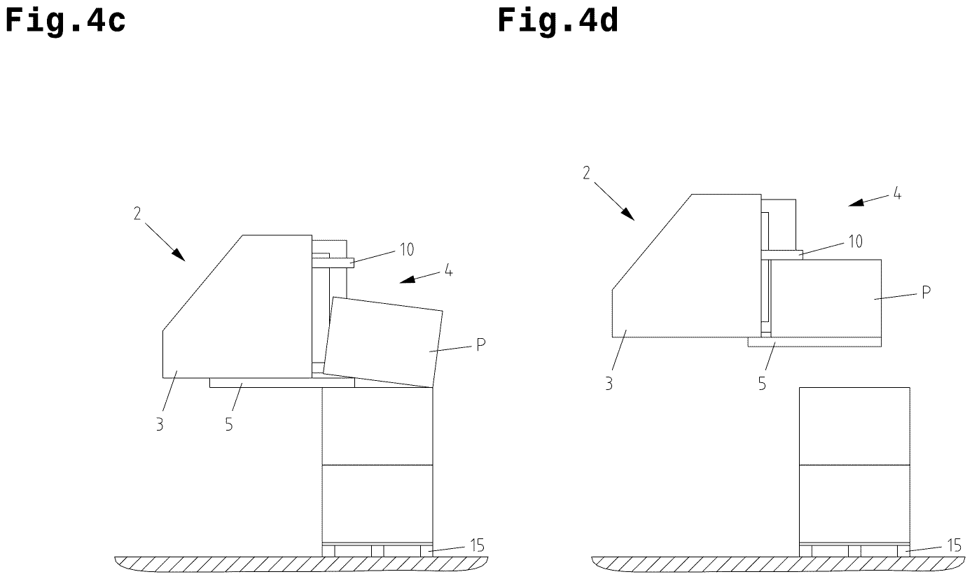

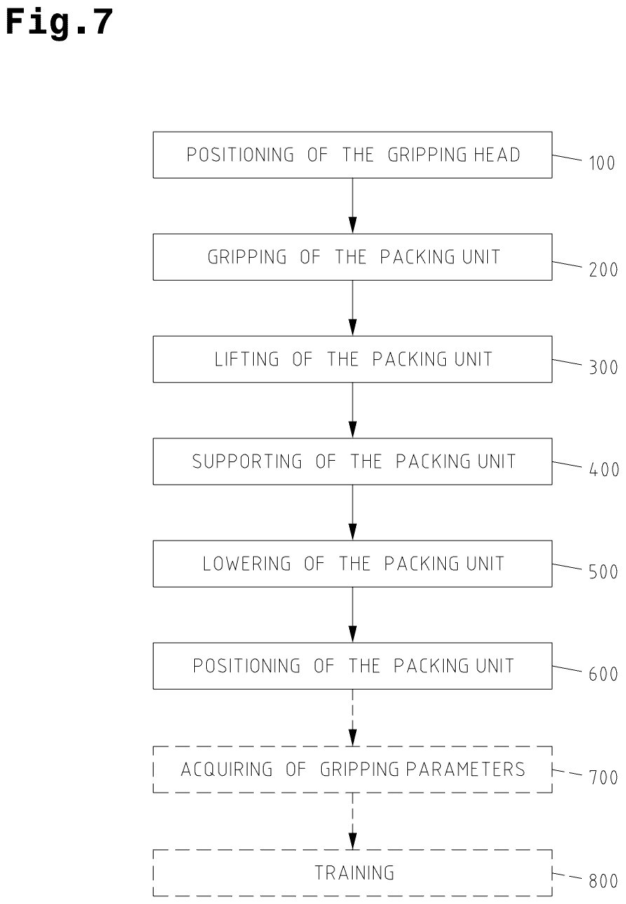

FIG. 4a to FIG. 4d show a process of handling a packing unit P, in particular of removing the packing unit P from a packing unit stack or packing unit container. The individual steps of the method are described in detail in the following with reference to FIG. 7 to FIG. 12.

The packing units P can be stacked on a load carrier 15, for example on a pallet. Alternatively, the packing units P can also be provided or stacked on a conveying system or a floor.

When handling the packing unit P, first a positioning 100 of the gripping head 2 in front of the packing unit is performed. If a contacting element 10 is present, the gripping head 2 can first be moved downwards until the contacting element 10 touches an upper edge of the packing unit P. This is shown in FIG. 4a. Where applicable, the touching of the upper edge is detected by the fact that the contacting element 10 is moved from a contacting position into an actuating position. To monitor this, the gripping head 2 can comprise a contacting sensor mechanism 11 as represented by a dashed line in FIG. 4a. For the sake of clarity, the contacting sensor mechanism 11 is not shown in FIG. 4b to FIG. 4d.

The gripping head 2 can subsequently be lowered so far until the loading tongue module 5 is aligned with a lower edge of the packing unit P. This is shown in FIG. 4b. For this purpose, the contacting element 10 can be pivoted away or, as in FIG. 4b, moved upwards so that it does not impede the movement of the gripping head 2.

Once the gripping head 2 is positioned, a gripping 200 of the packing unit P can be performed by establishing a connection between the gripping module 4 and the packing unit P, as is also shown in FIG. 4b. One or more of the available gripping units 41 can thereby be selectively used.

FIG. 4c shows a lifting 300 of the packing unit P, wherein the gripping module 4 is moved in the lifting direction Y relative to the loading tongue module 5. The packing unit P is thereby lifted. In the example shown, the lifting 300 comprises in particular a tipping of the packing unit P. A gap is thus formed beneath the packing unit P into which the loading tongue module 5, in particular the loading tongue(s), can be inserted, thus supporting 400 the packing unit P from below.

By the gripping module 4 being moved downwards in the direction of the loading tongue module 5, a lowering 500 of the packing unit P onto the loading tongue 51 is performed.

After the lowering 500 of the packing unit P, the connection between the gripping module 4 and the packing unit P is released, as can be seen in FIG. 4d. A positioning 600 of the packing unit P on the loading tongue module 5 is preferably performed by the clamping unit, as is described in more detail in the following.

If the contacting element 10 is usable as a clamping element, it can thus also be used for fixing the packing unit P by moving it towards the loading tongue module 5 such that the packing unit P is fixed between the loading tongue module 5 or the loading tongue 51 and the contacting element 10 by clamping. This is also shown in FIG. 4d. Alternatively, a separate clamping element can be provided for this purpose.

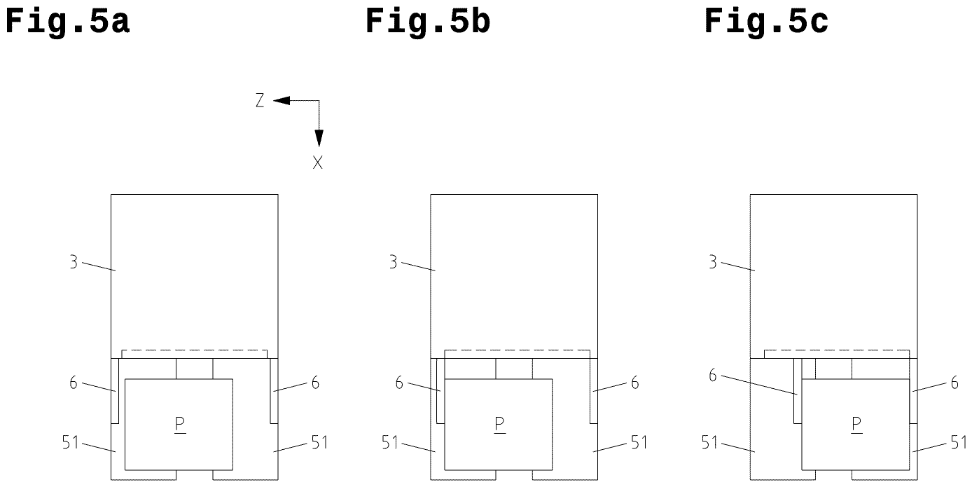

FIG. 5a to FIG. 5c show a top view of the positioning 600 of the packing unit P on the loading tongue module 5, in particular on the loading tongues 51.

Firstly, the clamping means 6 of the clamping unit can be provided in the previously described operating position, as shown in FIG. 5a. A first clamping means 6, the right-hand clamping means 6 in the example shown, is thereby provided in an abutment position. The other or second clamping means 6, the left-hand clamping means 6 in the example shown, is provided in an opened position, such that a spacing between the clamping means 6 is greater than a width of the packing unit P.

Subsequently, the second clamping means 6, which is in the opened position, is moved in the direction of the first clamping means 6, which is in the abutment position. This is shown in FIG. 5b.

Due to this movement of the second clamping means 6 parallel to the width direction Z, the packing unit P is slid in the direction of the first clamping means 6 and thus positioned or aligned on the loading tongue module 5, as is shown in FIG. 5c.

Alternatively, to the example shown in FIG. 5a to FIG. 5c, the clamping means 6 can also be moved towards one another such that the packing unit P is potentially centered on the loading tongue module 5.

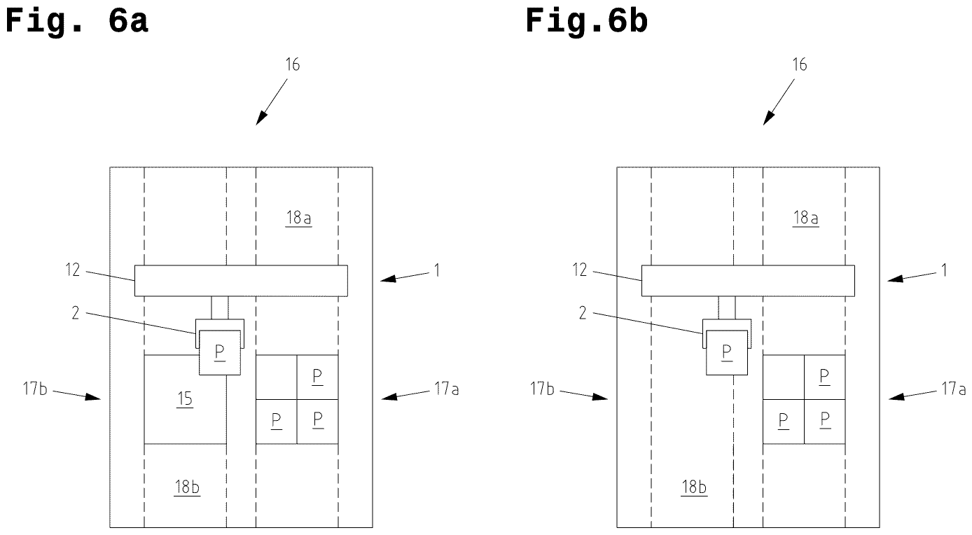

FIG. 6a and FIG. 6b show a section of an order-picking system 16 in top view, which comprises a transfer device 1.

Preferably, the transfer device 1 of such an order-picking system 16 comprises a gripping head 2 that is configured as previously described and is arranged on the manipulation unit 12. The manipulation unit 12 can be configured as a gantry robot or an articulated-arm robot as shown.

The transfer device 1 of the order-picking system 16 is configured to remove packing units P from a source location 17a, where, for example, a source load carrier 15 is provided, and to dispense them at a target location 17b, where, for example, a target load carrier 15 is provided. Packing units P can thereby be removed from the source load carrier 15, for instance, and transferred onto or into the target load carrier 15, as is shown in FIG. 6a. The transfer device 1 thus substantially provides a picking station.

It is expedient if the order-picking system 16 has a first provisioning device 18a for the auto-mated transport of the packing units P to the source location 17a and/or for the automated transport of the packing units P or of the (source) load carriers 15 from the source location 17a. The first provisioning device 18a can, in particular, comprise a conveying system for transporting the packing units P and/or load carriers 15.

In addition, it is advantageous if the order-picking system 16 comprises a second provisioning device 18c for the automated transport of (target) load carriers 15 to the target location 17b and/or transport of the packing units P from the target location 17b. The provisioning devices are represented in FIG. 6a and FIG. 6b with dashed lines.

In the example shown in FIG. 6a, the packing units P are provided at the source location 17a in an automated manner by means of the first provisioning device 18a, such as on a (source) load carrier 15. A (target) load carrier 15 is provided at the target location 17b by means of the second provisioning device 18b onto which packing units P, in particular according to a picking order, are to be transferred.

FIG. 6b shows a further example, wherein packing units P are provided at the source location 17a in an automated manner by means of the first provisioning device 18a, such as on a (source) load carrier 15. At the target location 17b, the packing units P are directly placed onto a conveying surface of the provisioning device. For this purpose, the provisioning device comprises a conveying system that provides the conveying surface. The conveying system can thereby comprise a stationary conveying system, such as a roller or belt conveyor, which provides the conveying surface. Alternatively, the conveying system can comprise a mobile conveying system that comprises a plurality of driverless transport vehicles, the placement surfaces of which each provide a conveying surface.

FIG. 7 is a schematic representation of a method for handling the packing unit P, wherein initially the positioning 100 of the gripping head 2 in front of the packing unit P is performed. This can be performed as described in connection with FIG. 4a and FIG. 4b.

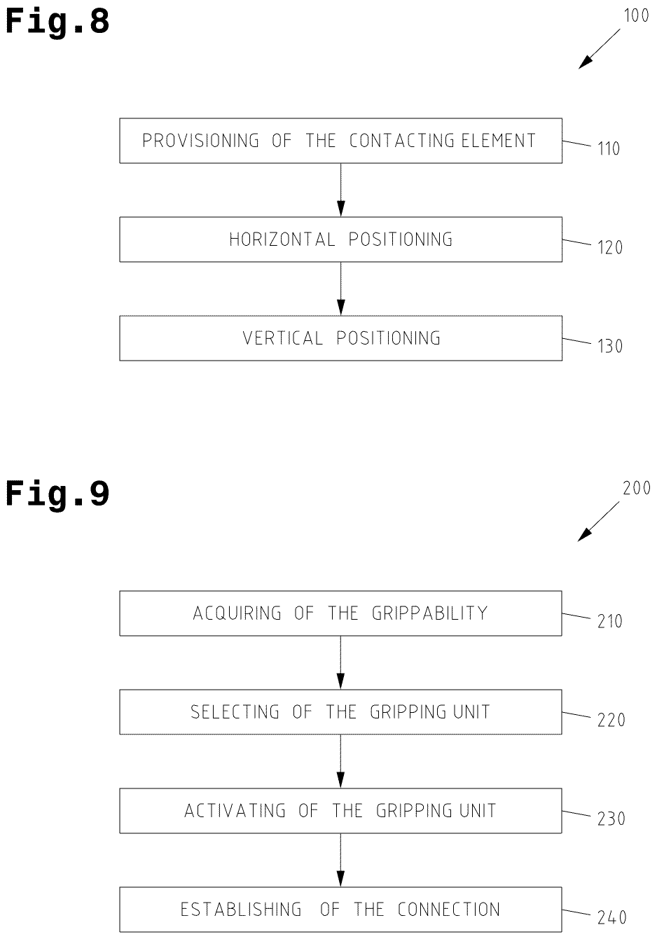

The positioning 100 of the gripping head 2 advantageously comprises the steps shown schematically in FIG. 8, wherein a first step is preferably a provision 110 of the previously described contacting element 10 in the contacting position.

Furthermore, in a next step a horizontal positioning 120 of the gripping head 2 is performed, wherein the gripping head 2 is moved into a first position in which the contacting element 10 protrudes beyond the packing unit P and the gripping module 4 is arranged parallel to the extending direction X at a distance to the contact side. The horizontal position can, for example, be monitored by the previously described camera unit 8. Such a position of the gripping head 2 is shown in FIG. 4a, for instance.

In addition, a vertical positioning 130 of the gripping head 2 is performed in a further step, wherein the gripping head 2 is moved (vertically) downwards until the contacting element 10 touches the upper edge of the packing unit P and is thereby moved from the contacting position into the actuating position. This can be monitored by the contacting sensor mechanism 11, for instance. A stack height is determined by this ‘contacting’. The gripping head 2 is subsequently moved or lowered further downwards by a certain adjusting path until the loading tongue module 5 is aligned with a lower edge of the packing unit P. The adjusting path can be derived from the determined stack height and a known height of the packing unit P, for instance.

After positioning 100 of the gripping head 2, a gripping 200 of the packing unit P by the gripping module 4, in particular by one or more of the gripping units 41 of the gripping module 4, can be performed. A releasable connection between the selected gripping unit 41 and the contact side of the packing unit P is thereby established. Establishing the releasable connection can, in particular, be performed by applying a vacuum if a gripping unit 41 of the vacuum gripping type is used, or by a positive engagement of the gripping unit 41 and a structured surface of the packing unit P, in particular bars 14, if a gripping unit 41 of the positive gripping type is used, as is shown by way of example in FIG. 3a or FIG. 3b.

If the gripping module 4 has a plurality of gripping units 41 of different gripping types, the gripping 200 can be performed as shown in FIG. 9. An acquisition 210 of the grippability of the packing unit is then first performed by the control system 7.

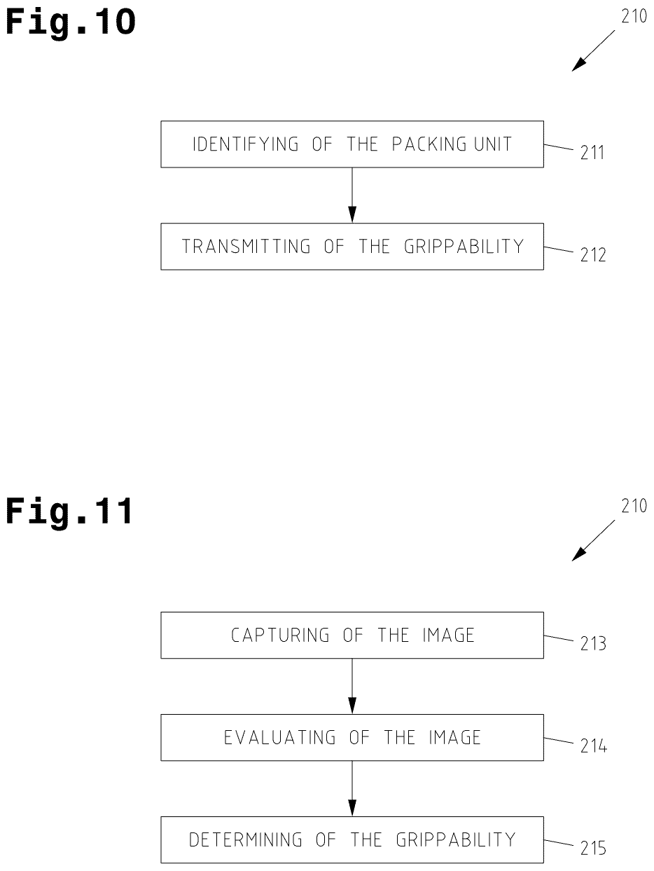

If the grippability of the packing unit P is known or stored in the electronic memory 71, the acquisition 210 of the grippability can then be performed as shown in FIG. 10, for example. An identification 211 of the packing unit P is thereby performed first. This can be performed by an identification marker of the packing unit P being acquired by the control system 7. A transmission 212 of the grippability regarding the identified packing unit P from the electronic memory 71 to the control system 7 can then be performed.

Alternatively, in particular if the grippability is not known, the acquisition 210 of the grippability can be performed as shown in FIG. 11, for example. For this purpose, a capturing 313 of an image of the contact side can be performed by means of the previously described image capturing system 9, which can subsequently be evaluated regarding a surface property.

The control system 7 can comprise an evaluation unit for this purpose. An evaluation 314 of the image can thus be performed by means of the evaluation unit of the control system 7. It is particularly preferable for the evaluation unit to comprise an algorithm for image recognition, in particular a machine learning model, for this purpose.

A determination 215 of the grippability can be performed based on the detected surface property. This can also be performed in an automated manner by the control system 7, in particular by the evaluation unit, preferably by the machine learning model.

A selection 220 of the gripping unit(s) that is/are suitable for lifting the packing unit P is performed by the control system 7 based on the acquired grippability.

An activation 230 of the selected gripping unit(s) is then performed by the control system 7. In particular, this can be performed by the selected gripping unit(s) being moved from the previously described inactive position into the active position.

Establishing 240 the releasable connection between the selected and activated gripping unit 41 and the contact side of the packing unit P can then be performed.

If the releasable connection is established, a lifting 300 of the packing unit P can be performed by moving the gripping module 4 away from the loading tongue module 5 in the lifting direction Y. The packing unit P is thereby lifted or tipped, as is shown by way of example in FIG. 4c. A gap is thus formed beneath the packing unit P. The loading tongue module 5, in particular the loading tongue(s), can then be inserted into this gap by moving it from the retracted initial position into the extended receiving position. A support 400 of the packing unit P is thereby performed by the loading tongue module 5. This is shown by way of example in FIG. 4c.

If the loading tongue module 5 is positioned beneath the packing unit P, a lowering 500 of the packing unit P can be performed by moving the gripping module 4 counter to the lifting direction Y in the direction of the loading tongue module 5. The packing unit P is thus substantially placed on the loading tongue module 5, in particular on the loading tongue(s) 51.

In a next step, a positioning 600 of the packing unit P on the loading tongue module 5 can be performed, wherein the packing unit P is preferably slid by the clamping means 6 of the clamping unit on the loading tongue module 5 and thus moved into a defined position.

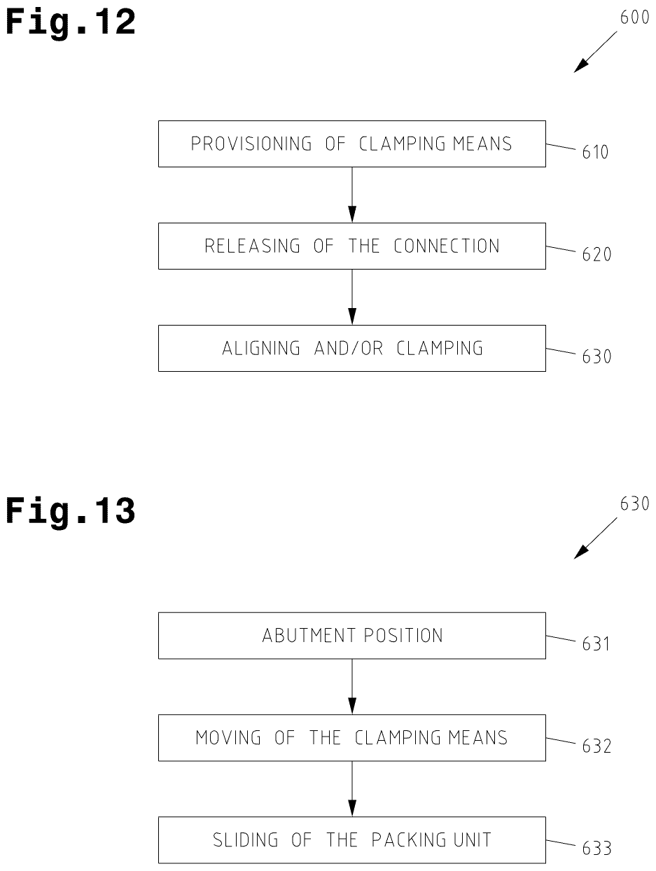

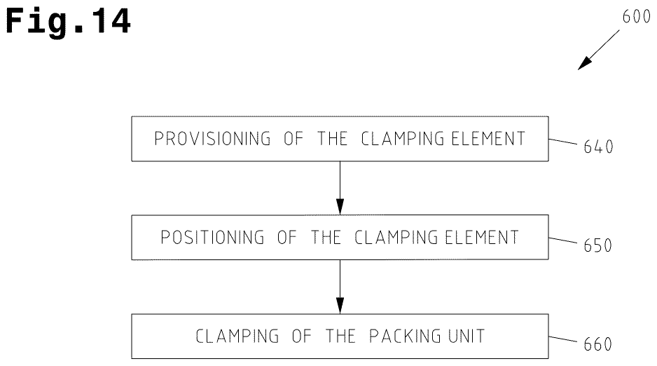

The positioning 600 is preferably performed as shown schematically in FIG. 12 and described in connection with FIG. 5a to FIG. 5c. A provision 610 of the clamping means 6 in the operating position and a release 710 of the releasable connection between the gripping unit 41 and the packing unit P is first performed. The packing unit P can thus be freely slid on the loading tongue module 5.

A spacing between the clamping means 6 can subsequently be reduced as previously described in order to slide and/or fix the packing unit P on the loading tongue module 5 by clamping. The alignment and/or clamping 630 of the packing unit P can thus be performed.

The alignment and/or clamping 630 of the packing unit P can, in particular, comprise a provision 631 of a (first) clamping means 6 of the clamping unit in the abutment position and subsequently a movement 632 of the other clamping means 6 of the clamping unit in the direction of the clamping means 6 that is provided in the abutment position, as is described in connection with FIG. 5a to FIG. 5c. During the movement 632, the moved clamping means 6 is positioned against the packing unit P, whereby a sliding 633 of the packing unit P is performed. This is shown schematically in FIG. 13.

In addition, the positioning 600 can comprise the steps shown in FIG. 12 of the provision 640 of a clamping element, of positioning 650 the clamping element, and of clamping 660 the packing unit P. In the provisioning 640 step, the clamping element, which protrudes beyond the gripping module 4 in the extending direction X, can be provided and in the positioning 650 step be positioned in a basic position in which the clamping element is positioned above the packing unit P and protrudes beyond the packing unit P in the extending direction X. As previously described, the clamping element can thereby be provided by the contacting element 10.

The clamping element can subsequently be moved parallel to the lifting direction Y in the direction of the loading tongue 5 during the clamping 660 step and be positioned against the packing unit P from above, such that the packing unit P is fixed between the loading tongue module 5 and the clamping element by clamping.

As shown by a dashed line in FIG. 7, the method can comprise an optional step of an acquisition 700 of gripping parameters and where applicable a step of training 800 the evaluation unit, in particular the machine learning model.

Data regarding a quality of the releasable connection can be acquired during acquisition 700 of the gripping parameters. It can thus be determined, for example, whether the connection will hold throughout the entire lifting 300, how strong a vacuum applied by a vacuum gripper is, or similar. This can be seen as a gauge as to whether the selected gripping unit 41 is suitable for lifting the packing unit P. The gripping parameters can be assigned to the gripping type and the detected surface property in order to provide training data.

The training 800 of the evaluation unit can be performed using such training data.

Finally, it should be noted that the scope of protection is defined by the patent claims. The description and the drawings should, however, be consulted when construing the claims. Individual features or combinations of features from the various example embodiments as shown and described can constitute separate inventive solutions.

In particular, it should be noted that in reality the represented devices can comprise more or fewer components than shown. The represented devices and their components can partially also be shown not to scale and/or in magnification and/or shrunk down.

### List of Reference Numerals

1 Transfer device
2 Gripping head
3 Base frame
31 Side walls
4 Gripping module
41 Gripping unit
42 Vacuum gripping means
43 Positive gripping means
5 Loading tongue module
51 Loading tongue
52 Connecting contour
6 Clamping means
7 Control system
71 Memory
8 Camera unit
9 Image capturing system
10 Contacting element
11 Contacting sensor mechanism
12 Manipulation unit
14 Bar
15 Load carrier
16 Order-picking system
17a, 17b Source location, target location
18a, 18b First, second provisioning device
100 Positioning of gripping head
110 Provisioning of contacting element
120 Horizontal positioning
130 Vertical positioning
200 Gripping of packing unit
210 Acquiring of grippability
211 Identifying of packing unit
212 Transmitting of grippability
213 Image capturing
214 Image evaluating
215 Determining of grippability
220 Selecting of gripping unit
230 Activating of gripping unit
240 Establishing the releasable connection
300 Lifting of packing unit
400 Supporting of packing unit
500 Lowering of packing unit
600 Positioning of packing unit
610 Provisioning of clamping means
631 Provisioning of first clamping means
632 Moving of second clamping means
633 Sliding of packing unit
640 Provisioning of clamping element
650 Positioning of clamping element
660 Clamping of packing unit
700 Acquiring of gripping parameters
800 Training
P Packing unit
X Extending direction
Y Lifting direction
Z Width direction
FE Front plane
RE Rear plane

1. A transfer device for handling packing units, comprising a gripping head that has a base frame, a gripping module for lifting a packing unit, and a loading tongue module for supporting the packing unit, wherein the base frame defines a front plane and a rear plane and forms two side walls which extend between the front plane and the rear plane, the gripping module is mounted on the base frame so as to be movable in a lifting direction relative to the loading tongue and relative to the base frame, and the loading tongue is mounted on the base frame so as to be movable in an extending direction between a retracted initial position and an extended receiving position relative to the base frame and relative to the gripping module, characterized in that
the gripping module has a plurality of gripping units of different gripping types, which are configured to contact a contact side of the packing unit and are alternately activatable, and in that the transfer device has a control system that is configured to acquire a grippability of the packing unit, to determine a gripping type based on the grippability that is suitable for lifting the packing unit, to select a gripping unit corresponding to the determined gripping type, and to initiate an activation of the selected gripping unit.

2. The transfer device according to claim 1, characterized in that the gripping types are selected from a group comprising one or more nonpositive gripping types and/or one or more positive gripping types.

3. The transfer device according to claim 1, characterized in that the control system is configured to access master data of the packing unit stored in an electronic memory and/or to store master data of the packing unit in the electronic memory.

4. The transfer device according to claim 1, characterized in that the control system has an image capturing system for capturing an image of the contact side of the packing unit and an evaluation unit, wherein the evaluation unit is configured to detect a surface property of the contact side based on an image captured by the image capturing system and to determine the grippability based on the surface property.

5. The transfer device according to claim 4, characterized in that the control system has a monitoring unit which is configured to acquire the gripping parameters during lifting of the packing unit and to store training data in an electronic memory, wherein the training data comprise the determined grippability and acquired gripping parameters and wherein the evaluation unit for detecting the grippability comprises a machine learning model which can be trained using the training data.

6. The transfer device according to claim 1, characterized in that the gripping head has a clamping unit for fixing the packing unit, which comprises two interacting clamping means, which are mounted on the base frame so as to be movable relative to one another in order to generate a clamping force.

7. The transfer device according to claim 6, characterized in that at least one of the clamping means is movable between a stowed position and an operating position, wherein the front plane and the outer surfaces of the side walls facing away from one another delimit an interior space and the at least one clamping means is arranged completely in the interior space in the stowed position and at least partially outside the interior space in the operating position.

8. A transfer device for handling packing units, comprising a gripping head that has a base frame, a gripping module for lifting a packing unit, and a loading tongue module for supporting the packing unit, wherein the base frame defines a front plane and a rear plane and forms two side walls which extend between the front plane and the rear plane, the gripping module is mounted movably on the base frame in a lifting direction relative to the loading tongue and relative to the base frame, and the loading tongue is mounted movably on the base frame in an extending direction between a retracted initial position and an extended receiving position relative to the base frame and relative to the gripping module, characterized in that
the gripping head has a clamping unit for fixing the packing unit which comprises two interacting clamping means which are mounted movably relative to one another on the base frame in order to generate a clamping force, wherein the at least one clamping means is movable between a stowed position and an operating position, wherein the front plane and the outer surfaces of the side walls facing away from one another delimit an interior space and the at least one clamping means is arranged completely in the interior space in the stowed position and at least partially outside the interior in the operating position.

9. The transfer device according to claim 8, characterized in that the loading tongue module comprises two loading tongues arranged next to one another, which along a side facing the respective other loading tongue have a lateral connecting contour with alternating protrusions and recesses, and the gripping head (2) can be brought into a first configuration in which the loading tongues are arranged at a minimum spacing to one another and the connecting contours of the loading tongues engage with one another, and a second configuration in which the loading tongues are arranged at a maximum spacing to one another, wherein the maximum spacing is greater than the minimum spacing.

10. A transfer device for handling packing units, comprising a gripping head that has a base frame, a gripping module for lifting a packing unit, and a loading tongue module for supporting the packing unit, wherein the base frame defines a front plane and a rear plane and forms two side walls which extend between the front plane and the rear plane the gripping module is mounted on the base frame so as to be movable in a lifting direction relative to the loading tongue and relative to the base frame, and the loading tongue is mounted on the base frame so as to be movable in an extending direction between a retracted initial position and an extended receiving position relative to the base frame and relative to the gripping module, characterized in that
the loading tongue module comprises two loading tongues arranged next to one another, which along a side facing the respective other loading tongue have a lateral connecting contour with alternating protrusions and recesses, and the gripping head can be brought into a first configuration in which the loading tongues are arranged at a first spacing to one another and the connecting contours of the loading tongues engage with one another, and a second configuration in which the loading tongues are arranged at a second spacing to one another, wherein the second spacing is greater than the first spacing.

11. The transfer device according to claim 10, characterized in that the gripping module is movable parallel to the extending direction between a retracted inactive position and an active position upstream of the inactive position in the extending direction.

12. The transfer device according to claim 11, characterized in that gripping units of the gripping module, in particular the gripping units of different gripping types, are movable independently of one another parallel to the extending direction between the inactive position and the active position.

13. The transfer device according to claim 10, characterized in that the gripping head comprises a clamping element that protrudes beyond the front plane, which is movable parallel to the lifting direction relative to the loading tongue and is mounted on the base frame in order to generate a clamping force between the clamping element and the loading tongue.

14. The transfer device according to claim 10, characterized in that the gripping head comprises a contacting element protruding beyond the front plane and a contacting sensor mechanism, wherein the contacting element is movable between a contacting position and an actuating position and the contacting sensor mechanism is configured to acquire a movement of the contacting element from the contacting position into the actuating position.

15. The transfer device according to claim 10, characterized in that the gripping head comprises a camera unit which is mounted on the front plane protruding beyond the front plane in the extending direction, wherein an optical axis of the camera unit extends parallel to the lifting direction.

16. The transfer device according to claim 10, characterized in that the gripping module comprises at least two gripping units of the same gripping type, which are movable relative to one another in the width direction in order to adjust a spacing between them.

17. The transfer device according to claim 10, characterized in that the side walls of the base frame are movable relative to one another in the width direction in order to adjust a spacing between them.

18. An order-picking system comprising a transfer device for handling packing units, wherein the transfer device is configured according to claim 10.

19. A method for handling a packing unit by a transfer device, in particular a transfer device according to claim 1, wherein the transfer device comprises a gripping head which has a base frame, a gripping module for lifting a packing unit, and a loading tongue module to support the packing unit, comprising the steps:
i) positioning of the gripping head in front of the packing unit;
ii) gripping of the packing unit by the gripping module;
iii) lifting of the packing unit by moving the gripping module relative to the base frame in a lifting direction, such that a gap is formed between the packing unit and a support upon which the packing unit rests;
iv) supporting of the packing unit by the loading tongue module by extending the loading tongue in an extending direction from a retracted initial position into an extended receiving position and inserting the loading tongue module into the gap, such that the loading tongue module extends beneath the packing unit;
v) lowering of the packing unit onto the loading tongue module by moving the gripping module relative to the base frame counter to the lifting direction in the direction of the loading tongue module;
vi) positioning of the packing unit on the loading tongue module; characterized in that
the gripping module has a plurality of gripping units of different gripping types and step ii) comprises the following steps:
acquiring a grippability of the packing unit by a control system, wherein the grippability indicates a gripping type that is suitable for lifting the packing unit;
selecting of a gripping unit from the gripping units of different gripping types depending on the grippability acquired by the control system;
activating of the selected gripping unit by the control system;
establishing of a releasable connection between the selected gripping unit and a contact side of the packing unit.

20. The method according to claim 19, characterized in that upon activation, a relative movement is performed between the selected gripping unit and the at least one other gripping unit of the plurality of gripping units, wherein the selected gripping unit is positioned upstream of the at least one other gripping unit in the extending direction.

21. The method according to claim 19, characterized in that the acquisition of the grippability comprises the following steps:
identifying of the packing unit;
transmitting of the grippability of the identified packing unit from an electronic memory to the control system.

22. The method according to claim 19, characterized in that the acquisition of the grippability comprises the following steps:
capturing an image of the contact side by an image capturing system;
evaluating the image by an evaluation unit in order to detect a surface property;
determining a grippability of the packing unit based on the surface property.

23. The method according to claim 21, characterized in that when acquiring the grippability, the grippability is either transmitted from an electronic memory to the control system or a captured image of the contact side is evaluated and the grippability of the packing unit is determined based on the surface property, depending on whether the grippability is stored in the electronic memory.

24. The method according to claim 22, characterized in that the evaluation of the image is performed by a machine learning model.

25. The method according to claim 24, characterized in that the method further comprises the following steps:
vii) acquiring gripping parameters which relate to a quality of the connection between the selected gripping unit and the contact side during steps ii), iii), iv) and/or v), wherein the gripping parameters are assigned to the gripping type and the detected surface property in order to provide training data;
viii) training a machine learning model using the training data.

26. The method according to claim 19, characterized in that the positioning according to step vi) comprises the following steps:
provisioning at opposite sides of the packing unit of two interacting clamping means of a clamping unit mounted on the base frame;
aligning and/or clamping of the packing unit between the clamping means by reducing a spacing between the clamping means.

27. The method according to claim 26, characterized in that the positioning according to step vi) comprises the following step:
releasing the connection between the gripping unit and the contact side after the lowering of the packing unit according to step v);
wherein the aligning and/or clamping of the packing unit is performed after the release of the connection.

28. A method for handling a packing unit by a transfer device, wherein the transfer device comprises a gripping head which has a base frame, a gripping module for lifting a packing unit, and a loading tongue module to support the packing unit, comprising the steps:
i) positioning of the gripping head in front of the packing unit;
ii) gripping of the packing unit by the gripping module;
iii) lifting of the packing unit by moving the gripping module relative to the base frame in a lifting direction, such that a gap is formed between the packing unit and a support upon which the packing unit rests;
iv) support of the packing unit by the loading tongue by extending the loading tongue in an extending direction from a retracted initial position into an extended receiving position and inserting the loading tongue module into the gap, such that the loading tongue extends beneath the packing unit;
v) lowering the packing unit onto the loading tongue by moving the gripping module relative to the base frame counter to the lifting direction in the direction of the loading tongue;
vi) positioning of the packing unit on the loading tongue;
wherein the step of positioning the packing unit on the loading tongue module comprises the following steps:
provisioning at opposite sides of the packing unit of two interacting clamping means of a clamping unit mounted on the base frame;
releasing the connection between the gripping unit and the contact side after the lowering of the packing unit;
aligning and/or clamping of the packing unit between the clamping means by reducing a spacing between the clamping means.

29. The method according to claim 28, characterized in that the alignment and/or clamping of the packing unit comprises the following steps:
provisioning of a first clamping means of the clamping means in an abutment position;
moving of a second clamping means of the clamping means in the direction of the first clamping means;
sliding of the packing unit in the direction of the first clamping means by the second clamping means until the packing unit is positioned against the first clamping means.

30. The method according to claim 29, characterized in that positioning of the packing unit on the loading tongue module comprises the following steps:
provisioning a clamping element which protrudes beyond the gripping module and is mounted on the base frame so as to be movable relative to the loading tongue module,
positioning of the clamping element in a basic position in which the clamping element is positioned above the packing unit and protrudes in the extending direction beyond the packing unit,
clamping of the packing unit by moving the clamping element from the basic position into a fixing position, wherein the clamping element is positioned against an upper edge of the packing unit and the packing unit is fixed by clamping between the clamping element and a loading tongue of the loading tongue module.

31. The method according to claim 30, characterized in that the positioning of the gripping head comprises the following steps:
provisioning of a contacting element mounted on the base frame so as to be movable relative to the loading tongue module, in a contacting position in which the contacting element protrudes beyond the gripping module;
horizontal positioning of the gripping head, wherein the gripping head is moved into a first position in which the contacting element protrudes beyond the packing unit and the gripping module is arranged parallel to the extending direction at a distance to the contact side;
vertical positioning of the gripping head wherein the contacting element is provided in a contacting position in which the contacting element is positioned at a lower end of the gripping module and the gripping head is lowered until the contacting element is moved from a contacting position into an actuating position by touching an upper edge of the packing unit, whereupon the gripping head is further lowered, such that the loading tongue module is aligned with a lower edge of the packing unit.
